(19) United States
(12) Patent Application Publication
(10) Pub. No.: US 2020/0122436 A1
(43) Pub. Date: Apr. 23, 2020

(54) GLAZING WITH LAMINATED INSERT OBSCURATION BAND

(71) Applicant: AGP America S.A., Ciudad de Panama (PA)

(72) Inventors: Mario Arturo MANNHEIM ASTETE, Lima (PE); Edward Enrique CUSTODIO SHEEN, Lima (PE); Charles Stephen VOELTZEL, Lima (PE)

(73) Assignee: AGP America S.A., Ciudad de Panama (PE)

(21) Appl. No.: 16/627,873

(22) PCT Filed: Jul. 2, 2018
(86) PCT No.: PCT/IB2018/054884

§ 371 Date: Dec. 31, 2019

Related U.S. Application Data
(60) Provisional application No. 62/528,127, filed on Jul. 2, 2017.

(30) Foreign Application Priority Data
Sep. 13, 2017 (CO) NC2017/0009260

(51) Int. Cl. B32B 17/10; C03B 23/035; C03C 27/10; B32B 27/30; B32B 27/40; B32B 27/08

(52) U.S. Cl. CPC B32B 17/10293; B32B 2605/08; B32B 17/10064; B32B 17/10137; B32B 17/10119; B32B 17/1077; B32B 17/10761; C03B 23/0357; C03C 27/10; B32B 27/30; B32B 27/40; B32B 27/08; B32B 2255/205; B32B 2307/41; B32B 2311/24; B32B 2315/08; B32B 2329/06; B32B 2375/00; B32B 2605/006; B32B 17/10036

(57) ABSTRACT

Glazing mounting systems, that make use of an adhesive to bond the glazing to a vehicle opening, require an obscuration to hide the adhesive from view and to protect the adhesive from ultra-violet radiation. An enamel ink is typically used to print the obscuration on the glass. However, glass with certain types of coatings and glass which will be chemically tempered is not compatible with enamel frits. Organic inks can be used but are expensive, difficult to work with and not as durable as an enamel frit. The obscuration of the present invention is produced by replacing the printed obscuration with an insert, which serves the same function of an obscuration printed on the glass, which is laminated as a part of the glazing.

### FIELD OF THE INVENTION

This invention relates to the field of laminated glazing.

### BACKGROUND OF THE INVENTION

In the early 1980s, the automotive industry began to change from rubber channel and adhesive strip fixed glazing mounting systems to polyurethane (PU) adhesive mounting systems. This was done in response to the poor safety performance of the old technology. The channel/adhesive strip mounted windshields were often dislodged upon impact in a crash allowing the occupants to be ejected from the vehicle. Today the adhesive strip is no longer used and the rubber channel mount is only seen on commercial and off-road vehicles.

The adhesive strip/rubber channel had some advantages. The adhesive strip was narrow and so could be hidden from view from the outside of the vehicle by a molding or trim strip. The rubber channel covered both the edge of the glass and the flange.

This had to change to enable the use of polyurethane. To obtain the required bond strength between the vehicle and the glass, the bead of polyurethane had to be wider than the adhesive strip had been. As a result, it was no longer practical or desirable to obscure the adhesive from view from the outside with a trim strip or molding. In addition, polyurethane adhesives need to be protected from ultra-violet light (UV) to prevent long-term degradation. As a result, a black enamel frit obscuration band had to be printed on the glass, to obscure the view of the polyurethane for the exterior of the vehicle and to protect the polyurethane from UV. This obscuration band of black enamel frit that encircles the daylight opening is commonly called the “black band.” The black band print is also often used to obscure other items mounted to the windshield such as the rear-view mirror button.

Black enamel frit is comprised of pigments, a carrier, binders and finely ground glass. Other materials are also sometimes added to enhance certain properties: the firing temperate, anti-stick, chemical resistance, etc. The black frit is applied to the flat glass using a silk screen, ink jet or other printing process prior to the heating and bending of the glass. During the bending process, the finely ground glass in the frit softens and fuses with the glass surface. The frit is said to be “fired” when this takes place. This is a vitrification process which is very similar to the process used to apply enamel finishes on bathroom fixtures, pottery, china and appliances.

The black obscuration has functional and aesthetic requirements. In addition to blocking UV, It must be durable, lasting the life of the vehicle under all exposure and weather conditions. The black obscuration must have a dark glossy appearance and be consistent from part to part and over the life of the vehicle. A part produced today must match up with one that was produced and in service 20 years ago. The parts must also match up with the other glazing in the vehicle which may not have been fabricated by the same manufacturer.

Particularly, black frit is not compatible with infra-red (IR) reflecting coatings as well as some other functional and aesthetic coatings. The coatings react with and are degraded by the frit if the frit is applied to the coated side. Likewise, the black frit can be degraded by the coating. If the glass is painted on the uncoated side and processed with the coated side down, the coating may be damaged from contact with the handling, conveying and supporting means. To solve this problem, on some laminates, the glass is first painted and fired and then coated, an expensive process. Another method used is to apply the coating to the number three surface of the interior glass layer, a less than optimal configuration with IR reflecting coatings, and paint the number two surface of the exterior glass layer.

Additionally, black frit is also not compatible with the chemical tempering process. The chemically tempered glass is made by submerging the glass in a bath of molten salt. Chemical tempering is an ion exchange process. Ions in the surface of the glass are exchanged for larger ions from the molten salt bath. The larger ions place the glass surface in compression. The resulting strength is a function of the glass composition, the bath, the temperature of the bath, and the time that the glass is treated. Compressive strengths as high as 1000 GPa can be achieved in this manner.

However, the black frits interfere with the ion exchange and as a result glass with black frit applied cannot be chemically tempered. If the glass layer must be chemically tempered, a fired black frit is not an option.

Chemically tempered glass is used in the production of both thin lightweight automotive glazing and heavier and thicker bullet resistant glazing (BRG).

On lightweight laminates where only one glass layer is chemically tempered, as is common practice today, the black frit can be applied to the layer that is not chemically tempered. If both layers are chemically tempered, black frit cannot be used.

Furthermore, bullet resistant glazing, BRG, provides resistant to penetration by projectiles (bullets). BRG laminates make use of combinations of various types of glass and plastics to absorb and dissipate the energy of the projectile, prevent penetration and protect the occupants of the vehicle from the projectile and any spalling of the glass. In addition, BRG glazing commonly includes chemically tempered glass layers. In a BRG laminate, glass layers may comprise various glass compositions such as borosilicate and aluminosilicate, in addition to soda-lime, as well as glass that has been thermally or chemically strengthened. Rigid plastic non-bonding layers comprising but not limited to polyurethane, acrylic and polycarbonate are also sometimes used.

Cold bending is a relatively new technology. As the name suggest, the glass is bent, while cold to its final shape, without the use of heat. On parts with minimal curvature a flat sheet of glass can be bent cold to the contour of the part. This is possible because as the thickness of glass decreases, the sheets become increasingly more flexible and can be bent without inducing stress levels high enough to significantly increase the long-term probability of breakage. Thin can be bent to large radii cylindrical shapes (greater than 6 m). When the glass is chemically, or heat strengthened the glass can endure much higher levels of stress and can be bent along both major axis. The process is primarily used to bend chemically tempered thin glass sheets (<=1 mm) to shape.

Cylindrical shapes can be formed with a radius in one direction of less than 4 meters. Shapes with compound bend, that is curvature in the direction of both principle axis can be formed with a radius of curvature in each direction of as small as approximately 8 meters. Of course, much depends upon the surface area of the parts and the types and thicknesses of the substrates.

The cold bent glass will remain in tension and tend to distort the shape of the bent layer that it is bonded to. Therefore, the bent layer must be compensated to offset the tension. For more complex shapes with a high level of curvature, the flat glass may need to be partially thermally bent prior to cold bending.

The glass to be cold bent is placed with a bent to shape layer and with a bonding layer placed between the glass to be cold bent and the bent glass layer. The assembly is placed in what is known as a vacuum bag. The vacuum bag is an airtight set of plastic sheets, enclosing the assembly and bonded together it the edges, which allows for the air to be evacuated from the assembly and which also applies pressure on the assembly forcing the layers into contact. The assembly, in the evacuated vacuum bag, is then heated to seal the assembly. The assembly is next placed into an autoclave which heats the assembly and applies high pressure. This completes the cold bending process as the flat glass at this point has conformed to the shape of the bent layer and is permanently affixed. The cold bending process is very similar to a standard vacuum bag/autoclave process, well known in the art, except for having an unbent glass layer added to the stack of glass.

Heat strengthened, full temper soda-lime float glass, with a compressive strength in the range of at least 70 MPa, can be used in all vehicle positions other than the windshield. Heat strengthened (tempered) glass has a layer of high compression on the outside surfaces of the glass, balanced by tension on the inside of the glass which is produced by the rapid cooling of the hot softened glass. When tempered glass breaks, the tension and compression are no longer in balance and the glass breaks into small beads with dull edges. Tempered glass is much stronger than annealed laminated glass.

Annealed glass is glass that has been slowly cooled from the bending temperature down through the glass transition range. This process relieves any stress left in the glass from the bending process. Annealed glass breaks into large shards with sharp edges. When laminated glass breaks, the shards of broken glass are held together, much like the pieces of a jigsaw puzzle, by the plastic the sheet metal of the vehicle by means of a structural adhesive. A 150 mm thick part made primarily of soda-lime glass, at 2.6 kg per square meter, could weigh as much as 350 kg per square meter. This compares to 13 kg for a typical 5.4 mm windshield. As a result, the exterior layer must be very strong. On a vehicle designed for a 5.4 mm thick windshield, we can go up to 6 mm but not much more without affecting the appearance of the vehicle. One of the desired attributes of a BRG equipped vehicle is that it not looks like an armored vehicle so as to not attract unwanted attention. To get the level of strength needed chemical tempering is often times used.

A black frit can be applied to any of the glass layers in the BRG laminate that are not chemically tempered. However, this is not an option on a BRG laminate where there is an offset between the exterior glass layer and the “package,” the smaller set of glass/plastic that provides much of the bullet resistance.

To solve this problem, black organic inks have been developed. As mentioned, the black obscuration has functional and aesthetic requirements. These requirements are difficult to meet with an inorganic vitrified black frit enamel and are even harder to meet with an organic. While organic inks are available for this application, the inks are expensive as well as difficult and expensive to apply and not as durable as inorganic fired inks. The organic inks can only be applied after the glass has been bent and chemically tempered. The ink must be allowed to dry and cure before the laminate is assembled.

Other methods which have been tried include printing the obscuration on the plastic bonding interlayer or film and the use of a substantially opaque plastic interlayer. However, these approaches generally require the use of an adhesion promoter as the dyes and pigments tend to interfere with the bonding of the interlayer to the glass and rigid plastic layers. It is also difficult to achieve the same level of opacity as achieved with a black frit. Another drawback is the much higher direct cost, lower throughput due to the added steps and higher labor required. In the case of a ballistic part where there is an offset between the outer layer edge of glass and the package, these solutions do not have the strength or durability needed.

It would be advantageous to be able to provide an obscuration that did not have these limitations.

### BRIEF SUMMARY OF THE INVENTION

The present invention is related to an obscuration insert added to the stack of a laminate that replaces the printed enamel frit obscuration. The insert is fabricated from any convenient material that can survive the autoclave process, achieve good adhesion to the plastic bonding layer and pass all functional, aesthetic, homologation and lifetime test requirements.

An additional bonding layer is needed to adhere the insert to the glass or plastic on each side. As the insert only needs to extend inboard to the clear daylight opening a transparent spacer is needed to fill the space enclosed by the insert in the daylight opening. This can be simply an additional layer of the same material as the plastic bonding layers or any other suitable transparent material such as a polycarbonate, polyurethane, acrylic, transparent ceramic, PET or glass. If the insert is thin enough, the clear spacer may not be needed.

Some advantages of the laminated of the present invention are the following:
Eliminates organic paint and associated cost
Less time and labor to assemble.
Improved durability.
Complete opacity.

### BRIEF DESCRIPTION OF THE DRAWINGS

FIG. 1A shows an isometric view of a BRG laminate with insert obscuration.

FIG. 1B shows a front view of a BRG laminate with insert obscuration.

FIG. 2 shows a side view of a BRG laminate with insert obscuration.

FIG. 3 shows an exploded view of a BRG laminate with insert obscuration.

FIG. 4A shows a section of a BRG laminate with insert obscuration.

FIG. 4B shows a section of a BRG laminate with insert obscuration and layers offset from edge.

FIG. 5A shows a cross section of a laminate with insert obscuration.

FIG. 5B shows a cross section of a laminate with insert obscuration.

FIG. 6A shows a cross section of a laminate with insert obscuration.

FIG. 6B shows a cross section of a laminate with insert obscuration.

FIG. 7 shows a cross section of a typical laminated windshield.

### REFERENCE NUMERALS

2 Glass.
4 Interlayer.
6 Obscuration Insert.
7 Polycarbonate.
8 Transparent spacer.
12 Infrared reflecting coating.
20 Package.
101 Exterior side of glass layer 1, number one surface.
102 Interior side of glass layer 1, number two surface.
103 Exterior side of glass layer 2, number 3 surface.
104 Interior side of glass layer 2, number 4 surface
201 Outer glass layer.
202 Inner glass layer.
203 Third glass layer.
204 Polycarbonate layer.

### DETAILED DESCRIPTION OF THE INVENTION

The present invention is directed to provide an obscuration insert added to the stack of a laminate that replaces the printed enamel frit obscuration. The laminate of the present invention comprises at least two glass or rigid transparent plastic layers having oppositely disposed major faces, at least two plastic bonding layers located between the first and second glass or rigid transparent plastic layers, and an obscuration insert located between the at least two plastic bonding layers.

The obscuration insert is fabricated from any convenient material that can survive the autoclave process, achieve good adhesion to the plastic bonding layer and pass all functional, aesthetic, homologation and lifetime test requirements. In preferred embodiments, the insert may be steel, aluminum, plastic or combination thereof.

The obscuration insert thickness of the present invention in some embodiments may be less than about one quarter of the thickness of the combined thickness of the two opposite plastic bonding layers.

An additional bonding layer is needed to adhere the insert to the glass or rigid transparent plastic on each side. As the insert only needs to extend inboard to the clear daylight opening, a transparent spacer is needed to fill the space enclosed by the insert in the daylight opening. This can be simply an additional layer of the same material as the plastic bonding layers or any other suitable transparent material such as a polycarbonate, polyurethane, acrylic, transparent ceramic, PET or glass. If the insert is thin enough, the clear spacer may not be needed.

Laminates, in general, are articles comprised of multiple sheets of thin, relative to their length and width, material, with each thin sheet having two oppositely disposed major faces and typically of relatively uniform thickness, which are permanently bonded to one and other across at least one major face of each sheet.

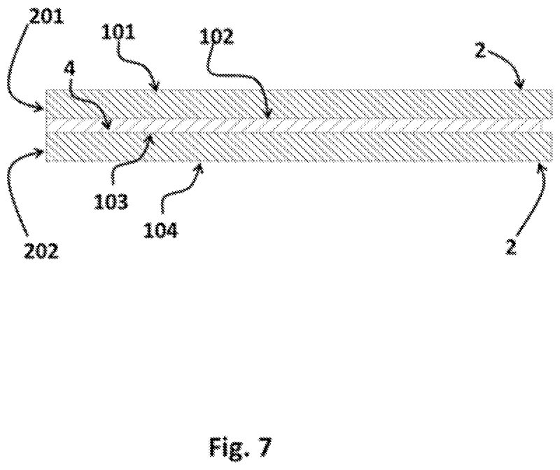

As shown in FIG. 7, laminate can be made of at least two layers of glass, the exterior or outer layer, 201 and interior or inner layer, 202 that are permanently bonded together by an interlayer 4 that may be of any plastic; it should be noted that the interlayer 4 can also be named as plastic interlayer 4 or plastic bonding layer 4. The glass surface that faces the exterior of a vehicle is referred to as surface one 101 or the number one surface. The opposite face of the outer glass layer 201 is surface two 102 or the number two surface. The glass 2 surface that is on the interior of the vehicle is referred to as surface four 104 or the number four surface. The opposite face of the interior layer of glass 202 is surface three 103 or the number three surface. Surface two 102 and surface three 103 are bonded together by the interlayer 4. Bullet resistant glazing can have additional layers of glass and rigid plastic which shall be sequentially numbered.

Rather than printing the obscuration on the glass, a sheet of metal or plastic is cut to size, painted if needed, and then inserted into the laminate after bending but before the autoclave.

Consequently, the obscuration insert 6 can be fabricated flat and cold bent to the glass shape during the autoclave process if the curvature of the part is not too complex. Otherwise, the obscuration insert 6 must be formed to the shape of the glass prior to lamination. The obscuration insert 6 may be fabricated in multiple segments that are assembled and fit together to improve fabrication cost and to allow for a better fit of the insert to the curved surface of the glass.

Thin steel and aluminum in the 0.38 mm to 1.00 mm range have been found to work well although other materials can be used. The insert is formed to the shape of the obscuration and then painted. A high gloss black powder coat has been used with excellent results. The appearance of the finished laminate is hard to distinguish from an organic or frit other than by the superior complete opacity of the metal insert. A plastic in the 0.05 mm to 1 mm range also can be used for some applications.

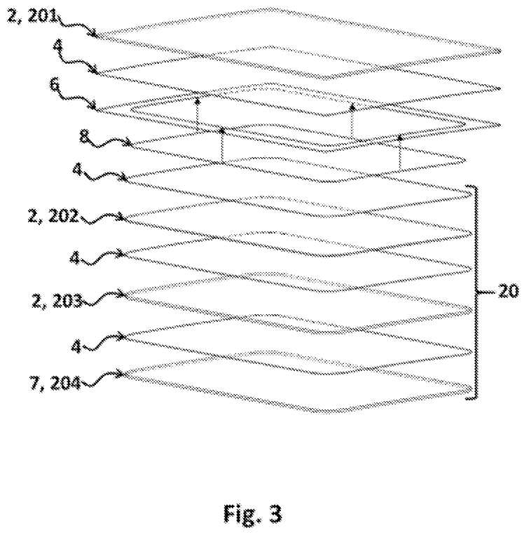

Additionally, as shown in FIG. 3, plastic bonding layers 4 are needed to bond the obscuration insert 6 to the adjacent glass or rigid non-bonding plastic layers 201, 202 of the laminate. If the thickness of the obscuration insert 6 is too great a transparent spacer 8 is also needed to fill the area enclosed and inboard of the obscuration insert 6. The transparent spacer 8 can be made of the same plastic bonding interlayer such as a PVB, PU or EVA or some other transparent material such as an acrylic, polycarbonate, polyurethane, PET, glass or combination thereof. The transparent spacer 8 is best fabricated in a thickness that is about the same as the obscuration insert 6. In addition, rigid transparent materials can be cold bent if the curvature of the surface is not too complex. The level of curvature that can be cold bent depends upon the thickness, the type of material, the composition of the adjacent layers, the thickness of the interlayer, and the autoclave cycle to be used to name some of the primary factors.

Otherwise, if the obscuration insert is substantially thinner than the total thickness of the plastic bonding layer, the transparent spacer may not be needed. For instance, in some embodiments of the invention, the obscuration insert thickness may range from any between 0.05 mm to 3.00 mm or between 0.5 mm to 1.00 mm. For standard non-BRG automotive windshield thicknesses, the insert thickness should be less than ¼ of the combined total thickness of the two opposite plastic bonding layers. FIG. 3 shows an exploded view of a BRG laminate of a vehicle. Speaking from the outside to the inside, the laminate comprises four glass or rigid transparent plastic layers, a first glass layer 201, a second glass layer 202, a third glass layer 203 and a polycarbonate layer 204. Interlayers 4 bond each of the glass layers 201, 202, 203 and polycarbonate layer 204. An obscuration insert 6 and a transparent spacer 8 PU layer are located between glass layers 201 and 202 and an additional plastic bonding layer 4 serves to bond the obscuration insert 6 to the glass layer 202 and the transparent spacer 8. The outer glass layer 201, is larger than the package 20, which is offset inboard to allow the part to fit into the unmodified opening of a vehicle designed for a conventional thin safety glazing.

The maximum thickness of an obscuration insert that can be used without a transparent spacer will depend upon the plastic bonding layer material, the autoclave cycle used, and the composition of the adjacent layers. Thicker stronger layers can accommodate a larger thickness mismatch than thinner weaker layers. This is because of the change in thickness that can occur when there is a mismatch. The plastic bonding layer softens during the lamination process and can accommodate some of the difference in thickness. However, if the difference is greater than what can be accommodated, the glass will be left in tension which increases the probability of breakage. Thicker stronger glass layers can withstand higher tension.

Laminates comprising more than two major glass or rigid plastic layers may have the obscuration located between any set of adjacent layers.

### Embodiment 1

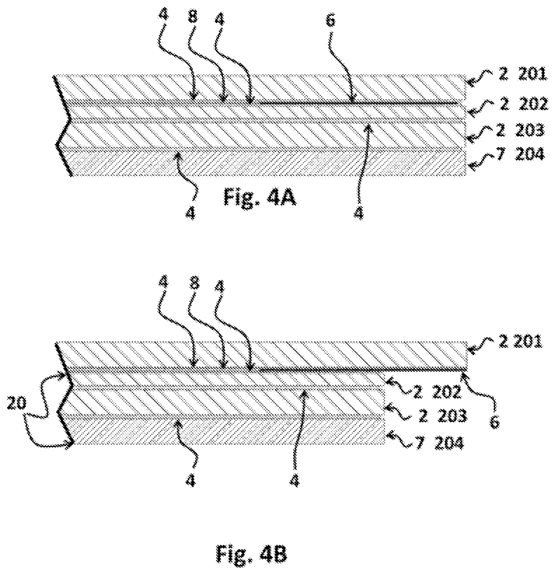

FIG. 4A shows a cross-section of a BRG laminate for a military vehicle. The laminate is comprised of a 6 mm chemically tempered outer glass layer 201, a 0.5 mm plastic PU interlayer 4 serving to bond the outer glass layer 201 to the 0.5 mm aluminum black powder coated obscuration insert 6 and a 0.5 mm transparent spacer 8 PU layer inside of the obscuration insert 6, a 0.5 mm plastic PU interlayer 4 serving to bond the obscuration insert 6 and the transparent spacer 8 to an interior 3 mm inner glass layer 202, a first plastic bonding layer of 1 mm of plastic PU 4 serves to bond the 3 mm inner glass layer 202 to a 6 mm third glass layer 203, and a second plastic bonding layer 1 mm of plastic PU 4 serves to bond the third glass layer 203 to a 6 mm polycarbonate layer 204.

### Embodiment 2

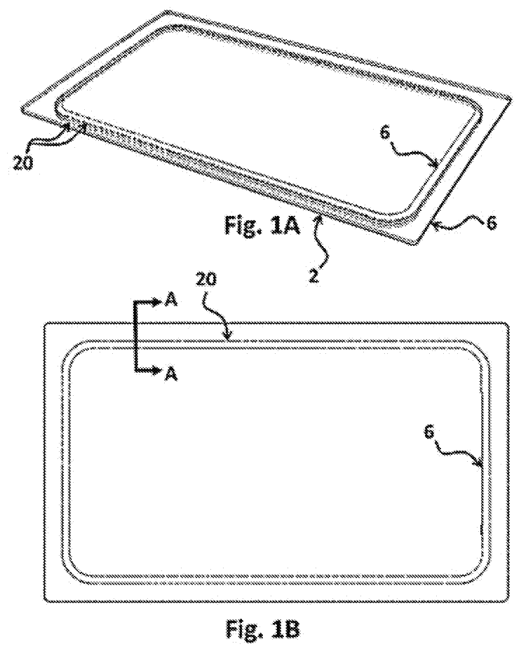

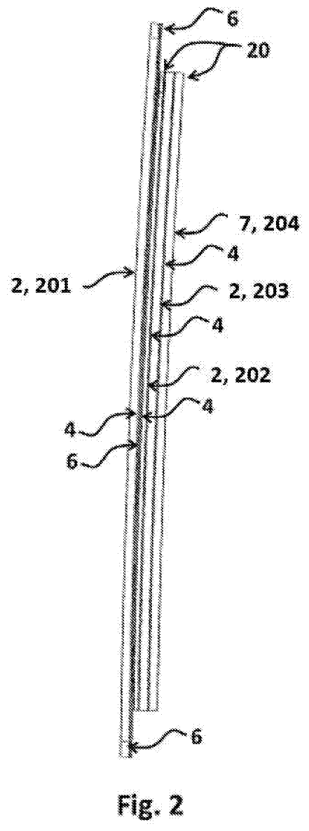

FIGS. 1A, 1B, 2, 3 and 4B shows a BRG laminate for a civilian vehicle. The laminate comprises a 6 mm chemically tempered outer glass layer 201, a 0.5 mm plastic PU interlayer 4 serving to bond the outer glass layer 201 to an 0.5 mm aluminum black powder coated obscuration insert 6 and a 0.5 mm transparent spacer 8 PU layer inside of the insert, an 0.5 mm plastic PU interlayer 4 serving to bond the obscuration insert 6 and the transparent spacer 8 to a 3 mm inner glass layer 202, a plastic bonding layer of 1 mm plastic PU 4, serves to bond the 3 mm inner glass layer 202 to a 6 mm third glass layer 203, and a plastic bonding layer of 1 mm plastic PU 4 serves to bond the third glass layer 203 to a 6 mm rigid transparent layer 204 made of polycarbonate 7. The outer glass layer 201, is larger than the package 20, which is offset inboard to allow the part to fit into the unmodified opening of a vehicle designed for a conventional thin safety glazing. The powder coat steel may get scratched during installation and handling but any scratch will not be visible from the exterior of the vehicle. Said offset may ranges between 10 mm to 25 mm.

### Embodiment 3

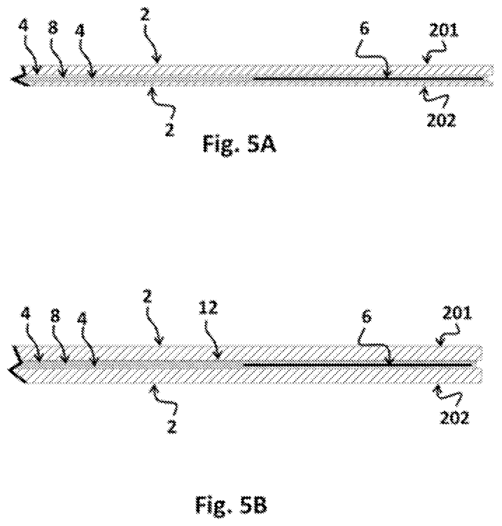

FIG. 5A shows a cross section of a laminate with a 2.1 mm outer glass layer 201, an 0.5 mm plastic PVB interlayer 4 serving to bond outer glass layer 201 to the 0.5 mm transparent spacer 8 PVB layer inside of an 0.5 mm black plastic obscuration insert 6, and an 0.5 mm plastic PVB interlayer 4 serving to bond the obscuration insert 6 and transparent spacer 8 to an 0.7 mm chemically tempered cold bent inner glass layer 202.

### Embodiment 4

FIG. 5B shows a cross section of a standard laminate with a 2.1 mm outer glass layer 201 having an infrared reflecting coating 12 in the surface two, a 0.5 mm plastic PVB interlayer 4 serving to bond the outer glass layer 201 to a 0.5 mm transparent spacer PVB layer 8 inside of an 0.5 mm black plastic obscuration insert 6, and an 0.5 mm plastic PVB interlayer 4 serving to bond the obscuration insert 6 and transparent spacer 8 to an 2.1 mm of inner glass layer 202.

### Embodiment 5

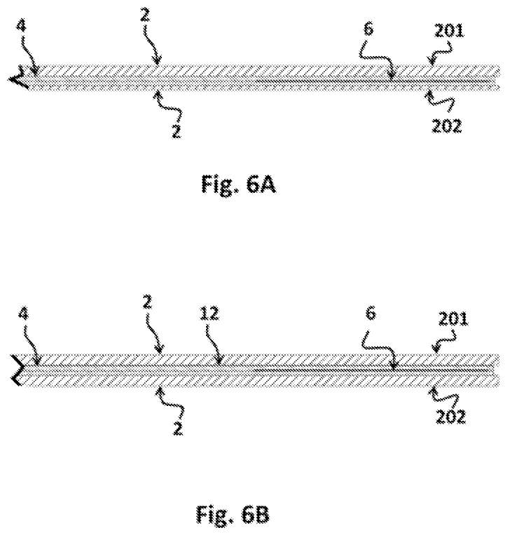

FIG. 6A shows a cross section of a laminate. A 2.1 mm outer glass layer 201 and a 0.7 mm chemically tempered inner glass layer 202 are bonded to each other by means of two 0.38 mm PVB plastic interlayers 4. A, 0.1 mm black plastic obscuration insert is sandwiched between the two PVB interlayers 4.

### Embodiment 6

FIG. 6B shows a cross section of a standard laminate with two 2.1 mm glass layers 2, an outer glass layer 201 and an inner glass layer 202, having an infrared reflecting coating 12 in the surface two of the outer glass layer 201, the two glass layers 201, 202 are bonded to each other by means of two 0.38 mm PVB plastic interlayers 4. A 0.1 mm black plastic obscuration insert 6 is sandwiched between the two PVB interlayers 4.

The forms of the invention shown and described in this specification represent illustrative preferred embodiments and it is understood that various changes may be made without departing from the spirit of the invention as defined in the following claimed subject matter.

1. A laminate comprising:
a) at least one glass or rigid transparent plastic layer having oppositely disposed major faces;
b) at least one bonding plastic layer having oppositely disposed major faces;
c) an obscuration insert having oppositely disposed major faces;
d) at least one additional bonding plastic layer having oppositely disposed major faces;
e) at least one additional glass or rigid transparent plastic layer having oppositely disposed major faces;
wherein the obscuration insert is positioned between the opposite faces of the at least one and the at least one additional plastic bonding layers;
wherein the two opposite major faces of the obscuration insert are bonded to the corresponding adjacent major faces of the at least one plastic bonding layer and the at least one additional plastic bonding layer;
wherein the surface of the at least one glass or rigid transparent plastic layer is bonded to the at least one bonding layer major surface opposite to the at least one bonding layer major surface bonded to the obscuration insert of the at least one bonding layer.
wherein the major surface of the at least one additional glass or rigid transparent plastic layer is bonded to the at least one additional bonding layer major surface opposite to the major surface bonded to the obscuration insert of the at least one bonding layer.

2. The laminate of claim 0 wherein the obscuration insert material is selected from the group consisting of steel, aluminum, plastic or combination thereof.

3. The laminate of claim 0 wherein the obscuration insert comprises multiple separate segments.

4. The laminate of claim 0 wherein at least one of the glass or rigid plastic layers is cold bent.

5. The laminate of claim 0 further comprising a heat strengthened glass layer.

6. The laminate of claim 0 wherein any of the glass layers are chemically strengthened.

7. The laminate of claim 0 wherein the glass layers comprises borosilicate glass.

8. The laminate of claim 0 wherein the glass layers comprises alumina silicate glass.

9. The laminate of claim 0 wherein the obscuration insert thickness is less than about one quarter of the thickness of the combined thickness of first interlayer or second interlayer.

10. The laminate of claim 0 wherein obscuration insert thickness ranges from 0.05 mm to 3.00 mm.

11. The laminate of claim 0 wherein the obscuration insert thickness ranges from 0.5 mm to 1.00 mm.

12. The laminate of claim 0 further comprising an additional glass layer or rigid plastic layers and bonding layers.

13. A vehicle comprising the laminate of claim 0.

14. The laminate of claim 0 further comprising at least one outer glass, one inner glass layer or one rigid plastic layer having an edge offset inboard from to the outboard edge of the obscuration insert.

15. The laminate of claim 14 wherein the offset ranges between 10 mm to 25 mm.

16. The laminate of claim 0 further comprising a transparent spacer, positioned within the obscuration insert, and having oppositely disposed of major faces wherein said faces are bonded to the opposite major face of the first interlayer and the opposite major face of the second first interlayer.

17. The laminate of claim 16 wherein said transparent spacer thickness is the same as the obscuration insert thickness.

18. The laminate of claim 16 wherein the transparent spacer material is selected from the group consisting of: PVB, PU, EVA, polycarbonate, acrylic, PET, polyurethane, glass or combination thereof.

19. The laminate of claim 16 wherein the transparent spacer is cold bent.
